(19) United States
(12) Patent Application Publication
(10) Pub. No.: US 2012/0121848 A1
(43) Pub. Date: May 17, 2012

(54) Composite materials for sports articles and method of manufacturing the composite materials

(76) Inventors: Robert Gold, Hamilton (CA); Eric Van Landschoot, Lynden (CA); Stanley Poulton, Scarborough (CA); Warren Harrison, Georgetown (CA)

(21) Appl. No.: 12/927,375

(22) Filed: Nov. 15, 2010

(51) Int. Cl. B32B 5/28; B32B 5/26

(52) U.S. Cl. 428/76

(57) ABSTRACT

The present invention relates to forming a laminated composite material that can be used to make sports articles, such as skis, snow boards, skate boards, surf boards, and wave boards and other articles of drastic mechanical properties. First, a plurality of layers of composite materials having fibres therein are assembled into a mould, the layers being arranged in a sandwich construction and super imposed on each other. A vacuum is applied to the mould, and a resin and catalyst mix is injected into the mould so as to evenly saturate, by means of the vacuum being applied to the mould, the layers of composite materials with the resin and catalyst mix. The layers of composite materials are then subjected to heat and pressure until the resin and catalyst mix has cured and imbedded the fibres of the composite materials together. The finished composite may vary in thickness between 4 mm and 30 mm, depending on end use.

The present invention relates to a composite material, sports articles produced from the composite material and a method for their manufacture. More specifically, the invention relates to a composite material which can be used to, for example, manufacture sports articles such as skis, snow boards, skate boards, surf boards, and wave boards and other articles of drastic mechanical properties.

### BACKGROUND OF THE INVENTION

The invention relates to composite materials, which are materials which have a thermohardening polymer matrix and a fibrous reinforcement, and possibly granular fillers and additives. The polymer matrix plays the role of a binder for the fibers of the reinforcement. It distributes and ensures the transmission of the forces to the fibers. The fibrous reinforcement, oriented (woven or non-woven) or random (non-woven) provides the finished composite with the necessary mechanical properties of strength and rigidity. These composites are used as raw material in the automotive industry, shipbuilding, aircraft industry, textile industry, sports article industry

The composites can be in the form of sandwich or laminated constructions, formed by a plurality of fibrous layers embedded in the matrix. The polymer matrix may be selected from among thermohardening or catalysed resins; examples are phenolic, polyester; vinylester; epoxide, polyamide, polycarbonate, polyacetal, vinyl styrenic esters. These “sandwich” or laminated composite constructions have the characteristic of being relatively lightweight and extremely rigid. This stiffness is such that mechanical deformability is very much reduced and mechanical properties generally enhanced.

U.S. Pat. No. 3,873,168 describes an article made of composite laminate having a body constituted by a polyamide cross-linkable resin and reinforced by a glass fiber. This body is inserted between two composite outer bearing portions whose matrix is also made of cross-linkable polyamide resin, and whose fibrous reinforcement is formed by a graphite fiber. The composite laminate according to U.S. Pat. No. 3,873,168 has the disadvantage of being too rigid and relatively expensive.

U.S. Pat. No. 3,779,851 discloses a composite laminate constituted of a plurality of graphite fiber sheets impregnated with epoxy resin. This laminate is presented as having a very high mechanical strength to weight ratio, as well as very low thermal expansion properties. Such specifications are desired for applications of these composite laminates in the manufacture of optical instruments (mirror). These are also extremely rigid composite laminates. This composite laminate is too stiff to be used as raw material in the manufacture of sports articles, such as skis, skate boards or snow boards for example, where a certain deformability or bending ability in both the longitudinal and latitudinal direction is needed. In addition, the fibrous reinforcement is exclusively made of carbon fibers. This method of construction, while suitable for use in the hi-tech areas of aero space, is too costly to be applied to the manufacture of sports articles.

U.S. Pat. No. 5,716,562 discloses a board made of a uniform composite mixture of carbon fibre and a thermohardening resin. However, this is a monocoque construction, in that it is uniform throughout (i.e. no core). Moreover, this construction does not recognize the need for different mechanical properties through the laminate, wherein the core should be rigid, and outer layers being provided with more flexibility.

A review of the state of the art shows that the manufacturers of sports articles are always looking for a materials having the mechanical properties of the composites in terms of maximum stiffness and minimum deformability, combined with a vibration dampening capacity, which is inexpensive and lightweight. These manufacturers also expect such a raw material to be easily industrially workable and shapable and, finally, to preserve its mechanical properties over a long period of time.

### SUMMARY OF INVENTION

The object of the present invention is to provide a new composite structure for making articles of manufacture, in particular sports articles, which are cost effective, lightweight and extremely rigid. This stiffness is such that mechanical deformability is very much reduced and mechanical properties generally enhanced.

This object, among others, is achieved by the present invention, which relates primarily to a composite laminate manufactured from multiple layers of composite materials made up of sheets of fabric, woven or non woven, embedded in a resin, which when catalysed and or heated becomes a hard continuous matrix bonding the fibres together. The laminated material may be consistent in composition through the article or contain a core material of substantially more rigid fibres, manufactured from high performance micro fibres, sandwiched between outer layers of more flexible fibre mats combinations. The stiffer core and more flexible outer layers are effective for board products that are subjected to extreme mechanical stress, because the outer layers are stressed more and would crack if rigid materials were used for their fabrication

According to one aspect of the present invention, there is provided a composite laminate for forming articles therefrom, the composite laminate being comprised of a plurality of layers of impregnated resin composite materials having fibres therein, the layers being arranged in a sandwich construction and super imposed on each other.

According to a further aspect of the present invention, there is provided a composite laminate for forming articles therefrom, the composite laminate being comprised of a plurality of flexible outer layers of impregnated resin composite materials having fibres therein; and a core material comprised of rigid resin impregnated fibres inserted between the plurality of outer layers of impregnated resin composite materials, the rigid resin impregnated fibres forming the core material being selected from the group consisting of carbon fibres, graphite fibres, and combinations of glass and carbon fibres wherein the plurality of outer layers are folded around each other so as to form a sandwich structure enclosing the core material, and the plurality of outer layers of impregnated resin composite materials have a mechanical strength lower than a mechanical strength of the rigid resin impregnated fibres forming the core material.

According to another aspect of the present invention, there is provided a composite board having a deck formed from the composite laminate according to the present invention.

According to yet another aspect of the present invention, there is provided a method of manufacturing a composite laminate, the method comprising assembling a plurality of layers of composite materials having fibres therein into a mould, the layers being arranged in a sandwich construction and super imposed on each other; applying a vacuum to the mould; injecting a resin and catalyst mix into the mould so as to evenly saturate, by means of the vacuum being applied to the mould, the layers of composite materials with the resin and catalyst mix; and subjecting the layers of composite materials to heat and pressure until the resin and catalyst mix has cured and imbedded the fibres of the composite materials together.

According to yet another aspect of the present invention, there is provided a method of manufacturing a composite laminate, wherein successive layers of fibre materials, woven or non woven mats, which are directionally oriented or randomly distributed, are manually coated with a polymer matrix, assembled and superimposed on each other in a mould and subjected to heat and pressure until the polymer matrix has cured and imbedded the fibres.

A further aspect of the present invention provides for the rapid removal of the article from the mould after curing, in that the mould is split evenly between top and bottom sections and the article is ejected cleanly after curing, reducing the level of secondary manufacturing necessary to produce a finished article.

Yet another aspect of the present invention provides for a method of manufacturing a composite laminate, the method comprising assembling a plurality of layers of composite materials having fibres therein into a mould, the layers being arranged in a sandwich construction and super imposed on each other; applying a vacuum to the mould; injecting a resin and catalyst mix into the mould so as to evenly saturate the layers of composite materials with the resin and catalyst mix; and subjecting the layers of composite materials to heat and pressure until the resin and catalyst mix has cured and imbedded the fibres of the composite materials together.

The advantage of the present invention is that it provides an improved composite material for making articles of manufacture, in particular sports articles, which are inexpensive, lightweight. and extremely rigid. This stiffness is such that mechanical deformability is very much reduced and mechanical properties generally enhanced.

### BRIEF DESCRIPTION OF THE DRAWINGS

A preferred embodiment of the present invention is described below with reference to the accompanying drawings, in which:

FIG. 1 illustrates a cross-section of the laminate according to the present invention, and which shows the core structure sandwiched between multiple layers of composite material;

FIG. 2 illustrates a cross-sectional view of the continuous laminate according to the present invention;

FIG. 3 illustrates a crossectional view of the laminate either with a core structure or with a continuous construction, where the layers of fibre material are folded around each other, to produce a reinforced profiled edge to the article; and

FIG. 4 illustrates the unique design of the mould, to assist removal of the article after curing and reduce the level of secondary manufacturing required for a finished article.

### DESCRIPTION OF THE PREFERRED EMBODIMENT

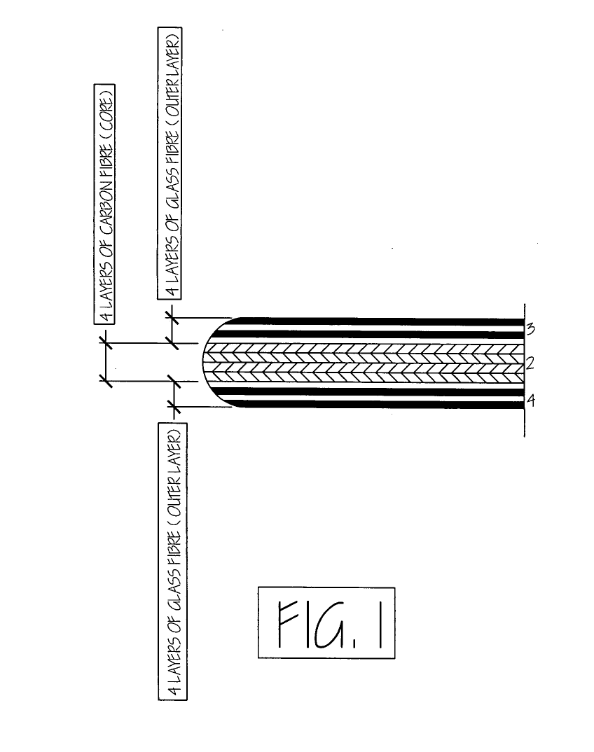

FIG. 1 shows the composite laminate 1 according to the invention. The latter is constituted of a structure having a core or central member 2 inserted or sandwiched between a plurality of flexible outer layers 3 and 4. In a preferred embodiment, the plurality of outer layers 3 and 4 of impregnated resin composite materials have a mechanical strength that is lower than a mechanical strength of the fibres forming the core 2. This core 2 is of a construction of more rigid fibre mat combinations than layers 3 and 4, which can be, in an alternative embodiment, pre-impregnated with resin or resin catalyst mix. The outer layers are, preferably however, comprised of non resin impregnated fabrics, which are then later saturated with a resin and catalyst mix under vacuum in a mould, as hereinafter described. The material comprising the layers is preferably the same for all of layers 3 & 4 and reinforced by fibres (fibrous materials). The fibrous material of the layers 3 and 4 is constituted from high performance fibres, which offer a higher level of flexibility and toughness than those comprising the central core, such as glass, Kevlar™ and Vectran™ (polyamide fibres and polyester fibers, respectrively) woven or non woven, and deliberately oriented in various directions or randomly arranged.

Advantageously, the fibrous material of the layers is in the form of: (i) linear continuous assemblies of (micro)fibres combined in strands or wicks of various shapes (glass strands, single strands, cabled strands, wicks, woven mat or non woven mat); ii.) non-linear strands (discontinuous), mats, chopped strand mat or continuous strand mat, surface mat, needled mat.

According to one arrangement of the invention, the layers 3 and 4 are each constituted by a plurality of layers; in this case 4 for the layers 3 and 4, respectively). In practice, the layer(s) 3 and 4 are obtained by superimposing the layers of fibrous and/or composite materials. Thus, the composite laminate 1 according to the present invention has a core structure and one or several layers forming the outer layers. These outer layers are formed by plies of fibres that are woven or unwoven, oriented or non-oriented, and which can be, in an alternative embodiment, pre-impregnated with resin or resin catalyst mix. The outer layers are, preferably, non resin impregnated fabrics, which are then later saturated with a resin and catalyst mix under vacuum in a mould, as hereinafter described.

In the case of the pre-impregnated composites the laminated sheet is preferably manufactured by assembling the layers in a jig and curing in a mould under low pressure/hot pressing or moderate pressure/hot pressing, the preferred method being moderate pressure/hot pressing.

In the case of non impregnated fabric the preferred method is to assemble the layers of fibrous and/or composite materials in a receiving mold under vacuum, then the fabric is saturated with a resin and catalyst mix. As a result of the vacuum process, the resin, once inserted into the mould, permeates throughout the fibrous and/or composite materials in the mold. The resulting saturated fabric is then cured in a heated mould under low pressure high temperature or moderate pressure high temperature conditions. One of the problems with assembling pre-impregnated fabrics in a mold is that such pre-impregnated material may have too much resin in certain locations, so that, when superimposed and cured in the mold, bubbling or imperfections may occur in the laminate, when the resin is cured. By assembling the layers of fibrous and/or composite materials in a receiving mold under vacuum, then saturating the fibrous and/or composite materials with a resin and catalyst mix, the resin, under the vacuum process, permeates the layers of fibrous and/or composite materials evenly.

In a preferred embodiment, between 1 and 6 layers of rigid fibre materials can form the core of the sandwich, with the outer layers, between 4 to 12, being formed of more flexible fibre combinations. It will also be apparent that orienting such fibrous material or reinforcing elements in different directions, will impart reinforcing in several directions i.e. across the directions of the fibres, and equalize the mechanical properties in all directions. For example, aligning these in only one direction would provide a laminate very strong across that direction, but rather weak along it. In a preferred embodiment of the present invention, the reinforcing core is manufactured from a group of high performance fibres consisting of carbon fibres, graphite fibres or combinations of carbon and graphite fibres.

In a preferred embodiment, a total thickness of the finished composite laminate according to the present invention is between 4 mm and 30 mm. For evident reasons of ease of manufacturing, the embodiments in which the polymer matrix of the core 2 and of the layers 3 and 4 is constituted by a single product are preferred.

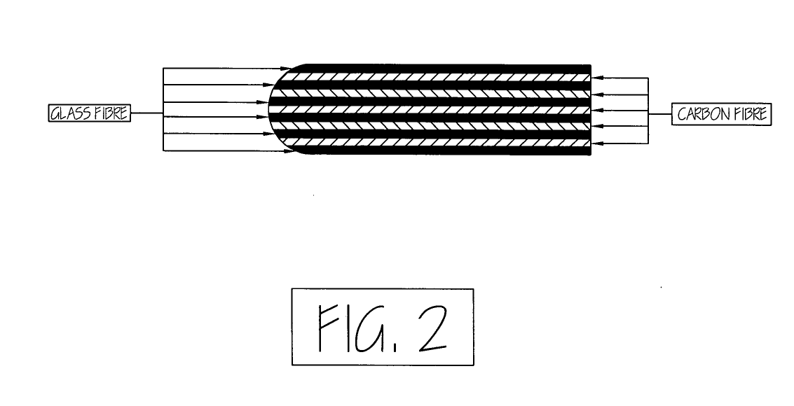

FIG. 2, illustrates the laminate consisting of 11 layers, which may be all of the same fibre or of mixtures of fibres. The arrangement of fibre mats vertically through the article will be uniform. The fibres mats may be pre-impregnated with resin or, preferably, consist of non impregnated mat, then impregnated with resin by vacuum.

In an alternative embodiment, chopped fibres constructions could also be used, in which case resin transfer techniques are the preferred method of manufacture.

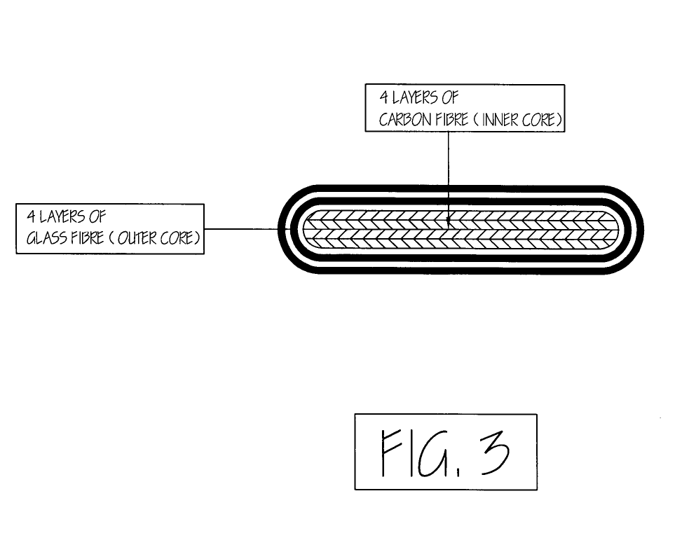

FIG. 3 shows composite laminate 3 according to the invention, where successive layers of non impregnated fibre materials, woven or non woven, may be folded around each other or around a reinforcing core and assembled in a mould. A vacuum is drawn on the mould and the construction saturated with a catalysed resin, which is injected into the mould. The resulting saturated material can then be subjected to heat and pressure and cured in a heated mould under medium pressure high temperature conditions, as hereinafter described.

Alternatively pre-impregnated fibres may be folded around each other or around a reinforcing core, and placed in a mould. The resulting construction can be subjected to heat and pressure and cured in the mould under high temperature medium pressure conditions.

In a preferred embodiment, between 1 and 6 layers of rigid fibre materials can form the core of the sandwich, with the outer layers, between 4 to 12, being formed of more flexible fibre combinations. It will also be apparent that orienting such fibrous material or reinforcing elements in different directions, will impart reinforcing in several directions ie. across the directions of the fibres, and equalize the mechanical properties in all directions. For example, aligning these in only one direction would provide a laminate very strong across that direction, but rather weak along it. In a preferred embodiment of the present invention, the reinforcing core is manufactured from a group of high performance fibres consisting of carbon fibres, graphite fibres and combinations of glass and carbon fibres.

In manufacturing the present invention, in a preferred embodiment, the stacked layers of the composite materials are placed into the mold at 200 F 90 C for between 2 to 3 minutes (after the resin has been injected therein, if non-impregnated mats are used), and pressure is then exerted in an amount of 150 psi (10 Kg/sq cm), then, increasing the heat applied to 135 C 270 F for between 6 to 8 minutes and pressure exerted in an amount between 400-500 psi. (28-36 Kg/sq cm). Finally, the pressure exerted is increased to 600 psi (40 Kg/sq cm) for 5 minutes. The finished composite laminate is then extracted from the mold, is allowed to cool, and the finishing operations, such as trimming, are undertaken.

Generally speaking however, in alternative embodiments, the manufacture of the present invention could be obtained applying heat at anywhere from 90 F to 275 F and pressure from 100 to 1,000 psi, (6 kg/sq cm to 60 Kg/sq cm) over time periods of 8-30 minutes. In any event, the person with ordinary skill in the art is capable of adjusting these parameters depending on the types of materials used.

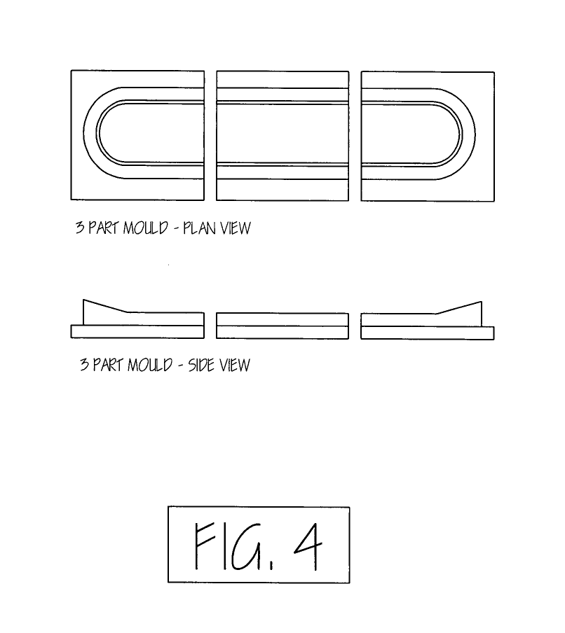

FIG. 4 illustrates the preferred profile and design of the mould. To facilitate removal of the composite sandwich from the curing mold it has been found advantageous to profile the corners of the mould and to design the mould to split into two equal sections, top and bottom. This arrangement has been found to allow; quick access to the cured article, rapid removal without any damage or distortion and minimum secondary finishing or machining.

Of course, the finished composite laminate of the present invention thus manufactured is lightweight, economical, and has the expected mechanical properties in terms of longitudinal bending and transverse stiffness, vibration damping, rotational stiffness and can be machined, using a range of wood working techniques well known to those skilled in the art, such as, trimming sanding, buffing, polishing and planning.

Further, the present invention can be used for manufacturing sports articles, such as, but not limited to skis, snowboards, skateboards and waveboards.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A composite laminate for forming articles therefrom, the composite laminate being comprised of:
a plurality of flexible outer layers of impregnated resin composite materials having fibres therein; and
a core material comprised of rigid resin impregnated fibres inserted between the plurality of outer layers of impregnated resin composite materials, the rigid resin impregnated fibres forming the core material being selected from the group consisting of carbon fibres, graphite fibres, and combinations of glass and carbon fibres
wherein the plurality of outer layers are folded around each other so as to form a sandwich structure enclosing the core material, and the plurality of outer layers of impregnated resin composite materials have a mechanical strength lower than a mechanical strength of the rigid resin impregnated fibres forming the core material.

2. The composite laminate of claim 1, wherein the core material is selected from the group consisting of high performance fibres such as carbon fibres, graphite fibres, and combinations of glass and carbon fibres impregnated with a resin.

3. The composite laminate of claim 1, wherein the core material comprises between 1 and 6 layers of the rigid impregnated fibres, and die plurality of outer layers of impregnated resin composite materials are comprised of 4 to 12 layers.

4. The composite laminate of claim 1, wherein the layers of impregnated resin composite materials are oriented in several directions along and across the laminate.

5. The composite laminate of claim 1, wherein a total thickness of the laminate is between 4 mm and 30 mm.

6. The composite laminate of claim 1, wherein the fibres of the layers of impregnated resin composite materials are selected from a group of high performance fibres comprising carbon fibres, glass fibres, polyamide fibres and polyester fibers.

7. The composite laminate of claim 1, wherein the composite laminate is subjected to heat and pressure until the resin has cured, forming a continuous bond through all of the layers to embed the fibres.

8. The composite laminate of claim 1, wherein the fibres of the composite materials can be woven or non woven.

9. The composite laminate of claim 1, wherein the fibres are oriented along the article to be formed, across the article or randomly.
